(19) United States
(12) Patent Application Publication
(10) Pub. No.: US 2012/0233840 A1
(43) Pub. Date: Sep. 20, 2012

(54) SOLAR CELL MODULE AND MANUFACTURING METHOD OF SAME

(75) Inventor: Takeshi MOTOYAMA, Monterrey City (MX)

(73) Assignee: SANYO ELECTRIC CO., LTD., Moriguchi-shi (JP)

(21) Appl. No.: 13/483,245

(22) Filed: May 30, 2012

Related U.S. Application Data
(63) Continuation of application No. PCT/JP2010/071285, filed on Nov. 29, 2010.

(30) Foreign Application Priority Data
Nov. 30, 2009 (JP) 2009-271217

(51) Int. Cl. B23P 11/00

(52) U.S. Cl. 29/428

(57) ABSTRACT

A squeezed sealing material from the drainage notch is prevented so that workability is improved by eliminating a cleaning work. A solar cell module includes a solar cell panel and a flame provided with: a main body; a fitting part disposed on the top of the main body and receiving the peripheral edge portion of the solar cell panel; and a drainage notch formed by cutting out the fitting part from a position near a front member of the solar cell panel to a position below the front member. A sealing material is applied to the fitting part with a spacing which extends more than 10 mm to 30 mm from the edge of the notch, and then the peripheral edge portion of the solar cell panel is inserted into the fitting part to attach the frame to the solar cell panel.

### CROSS-REFERENCES TO RELATED APPLICATIONS

This application is based on International Application PCT/JP2010/071285 which claims priority on the basis of Japanese Patent Application No. 2009-271217.

### TECHNICAL FIELD

This invention relates to a solar cell module and a method for manufacturing the solar cell module, and more particularly to a solar cell module with a frame.

### BACKGROUND ART

In recent years, solar cell modules, which extract electric power via photoelectric conversion of sunlight, have been widely utilized. In order for solar cell modules to bear various environmental burdens, such as snow loads and wind pressure, an aluminum frame is attached along the peripheral edge portion of a solar cell panel including solar cells.

The frame, in addition to a front member, imparts strength to the solar cell modules, which eliminates the necessity to increase the thickness of the front member to make large solar cell modules. Consequently, the solar cell modules do not increase in weight and can be handled readily. Thinning the thickness of the front member increases the amount of light passing through the front member, thereby improving power generation efficiency.

By the way, there is a level difference between the aforementioned frame and front member of the solar cell panel. After rainfall, rainwater may collect in the level difference region. For the purpose of preventing rainwater from pooling on the front member after rainfall, solar cell modules have been proposed that are provided with a frame with a drainage notch (see, e.g., PTL 1).

FIG. 20 is a cross-sectional view of the solar cell module including a solar cell panel attached to a frame with a drainage notch. A commonly used solar cell panel 10 includes a front member 12, such as a clear glass board, solar cells 11 encapsulated by an encapsulant 14, such as ethylene-vinyl acetate, and a back member 13, which is a sandwich type vinyl fluoride film with an aluminum foil interposed therein, to support the back side of the solar cell panel 10.

As described above, a frame 20 is attached to the peripheral edge portion of the solar cell panel 10 to impart mechanical strength and the frame 20 is provided with a fitting part 22 that receives the peripheral edge portion of the solar cell panel 10. In order to more reliably ensure the fit between the solar cell panel 10 and frame 20, a sealing material 60, such as silicone, is used to fix the peripheral edge portion of the solar cell panel 10 with the frame 20. In addition, a drainage notch 28 is formed in the fitting part 22 of the frame 20 to drain rainwater.

### CITATION LIST

### Patent Literature

PTL 1: Japanese Unexamined Utility Model Application Publication No. 1994-17257

### SUMMARY OF INVENTION

### Technical Problem

However, when the solar cell panel 10 is attached to the aforementioned frame 20 having the drainage notch 28 with the sealing material, the sealing material 60 that is applied to the inner side of the frame 20 may be squeezed out from the notch 28 onto the front member 12 as shown in FIG. 20. The squeezed sealing material 60 causes water to flow backward, as indicated by an arrow in FIG. 20, and therefore the notch 28 cannot properly drain water.

For this reason, since it is necessary to remove the sealing materials being squeezed to the front member 12, there are problems that a cleaning work for removing them takes time and effort, for example.

The present invention has been made in order to solve the above-described problems and has a first object to maintain a fine view and improve workability by preventing the sealing materials from being squeezed out from the drainage notch to eliminate the cleaning work, for example. The present invention has a second object to smoothly drain rainwater or the like from the drainage notch.

### Solution to Problem

The present invention is directed to a method for manufacturing a solar cell module including: a solar cell panel; and a frame having a fitting part receiving a peripheral edge portion of the solar cell panel and a drainage notch formed by cutting out the fitting part from a position near a front member of the solar cell panel to a position below the front member. In the method, the peripheral edge portion of the solar cell panel is inserted in the fitting part after a sealing material is applied to the fitting part with a predetermined spacing from an edge of the notch to attach the frame to the peripheral edge portion of the solar cell panel.

The flame may include a main body, and the fitting part may be positioned on the top of the main body. The fitting part may have a U-shape in cross section.

It is preferred that the predetermined spacing extends more than 10 mm to 30 mm from the edge of the notch.

The frame includes: a main body; and a U-shaped cross-section fitting part that is positioned on the top of the main body and receives the peripheral edge portion of the solar cell panel. A first recess is formed on a top surface of the main body which is included in a support portion on the lower side of the fitting part and is applied with the sealing material. A second recess is formed in a wall of the fitting part which stands perpendicular to the first recess and is applied with the sealing material.

32 g/m sealing material made of silicone resin may be applied to the first recess and second recess.

The first recess may have a width of 3.5 mm, and the second recess may have a width of 4.0 mm.

The present invention is directed to a solar cell module including: a solar cell panel; a frame including a fitting part that receives a peripheral edge portion of the solar cell panel; and a sealing material disposed between the peripheral edge portion of the solar cell panel and the fitting part. The frame has a drainage notch formed by cutting out the fitting part from a position near a front member of the solar cell panel to a position below the front member. The sealing material is applied to the fitting part with a predetermined spacing from an edge of the notch.

Side surfaces of the solar cell panel are exposed from the notch to the outside, and the sealing material is not provided on the side surfaces of the solar cell panel exposed from the notch to the outside.

### Advantageous Effects of Invention

According to the invention, cleaning the appearance is not necessary because the sealing materials are not squeezed out from the flame into the front member. Therefore, the working efficiency can be improved. In addition, since the squeezed sealing materials are prevented, it is possible to provide a solar sell module having an excellent appearance, and drain water from the notch without obstruction of the sealing materials.

### BRIEF DESCRIPTION OF DRAWINGS

FIG. 1 is a plan view of a solar cell module according to an embodiment of the invention.

FIG. 2 is a perspective view showing a relevant part of the solar cell module according to the embodiment of the invention.

FIG. 3 is a perspective view showing a relevant part of the solar cell module according to the embodiment of the invention.

FIG. 4 is a cross-sectional view showing a relevant part of the solar cell module according to the embodiment of the invention.

FIG. 5 is a cross-sectional view showing a relevant part of the solar cell module according to the embodiment of the invention.

FIG. 6 is a sectional view showing a relevant part of flames utilized in the solar cell module according to the embodiment of the invention.

FIG. 7 is a plan view showing assembly of a frame of the solar cell module according to the embodiment of the invention.

FIG. 8 is an exploded perspective view showing assembly of the frame of the solar cell module according to the embodiment of the invention.

FIG. 9 is a perspective view showing the assembled frame of the solar cell module according to the embodiment of the invention.

FIG. 10 is a perspective view showing the flames utilized in the solar cell module according to the embodiment of the invention.

FIG. 11 is a cross-sectional view showing the method for manufacturing the solar cell module and particularly how to insert the solar cell panel into the frame.

FIG. 12 is a cross-sectional view showing the method for manufacturing the solar cell module and particularly how to insert the solar cell panel into a notch of the frame.

FIG. 13 is a front view showing the flame utilized in the solar cell module according to the embodiment of the invention.

FIG. 14 is a plan view showing the notch region of the solar cell module manufactured according to a manufacturing method for the solar cell module of the invention.

FIG. 15 is a rear view showing the notch region of the solar cell module manufactured according to the manufacturing method for the solar cell module of the invention.

FIG. 16 is a plan view showing the notch region of the solar cell module manufactured according to a manufacturing method for the solar cell module of the invention.

FIG. 17 is a rear view showing the notch region of the solar cell module manufactured according to the manufacturing method for the solar cell module of the invention.

FIG. 18 is a plan view showing the notch region of the solar cell module manufactured according to a manufacturing method for the solar cell module of the invention.

FIG. 19 is a rear view showing the notch region of the solar cell module manufactured according to the manufacturing method for the solar cell module of the invention.

FIG. 20 is a cross-sectional view of the solar cell module including a solar cell panel attached to a frame having a drainage notch.

### DESCRIPTION OF EMBODIMENTS

With reference to the drawings, embodiments of the present invention will be described in detail. Through the drawings, like components are denoted by like numerals and, to avoid being redundant, will not be further explained.

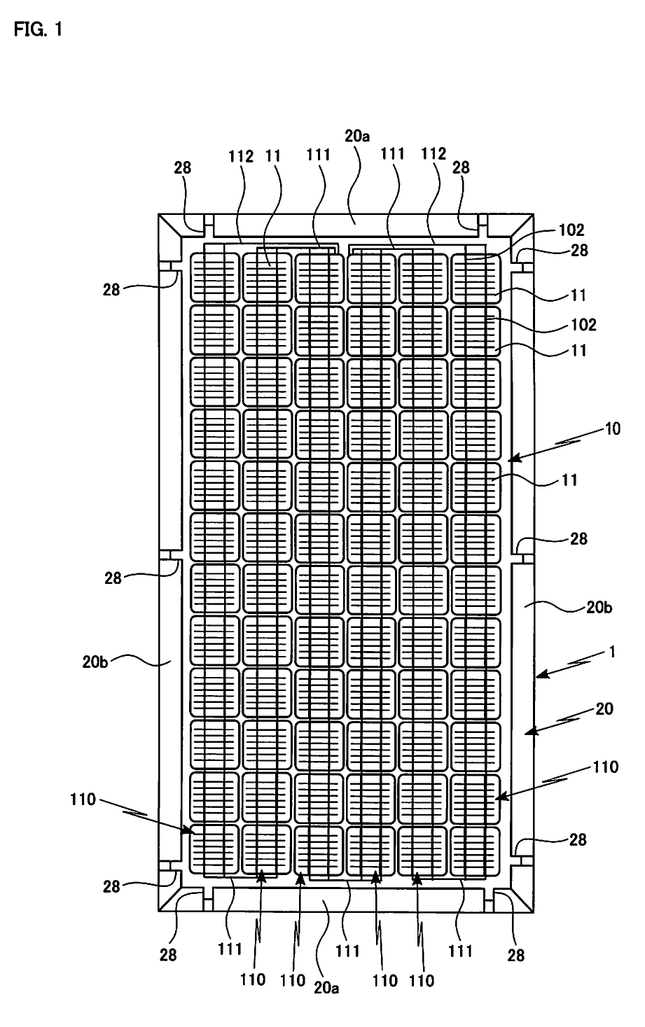

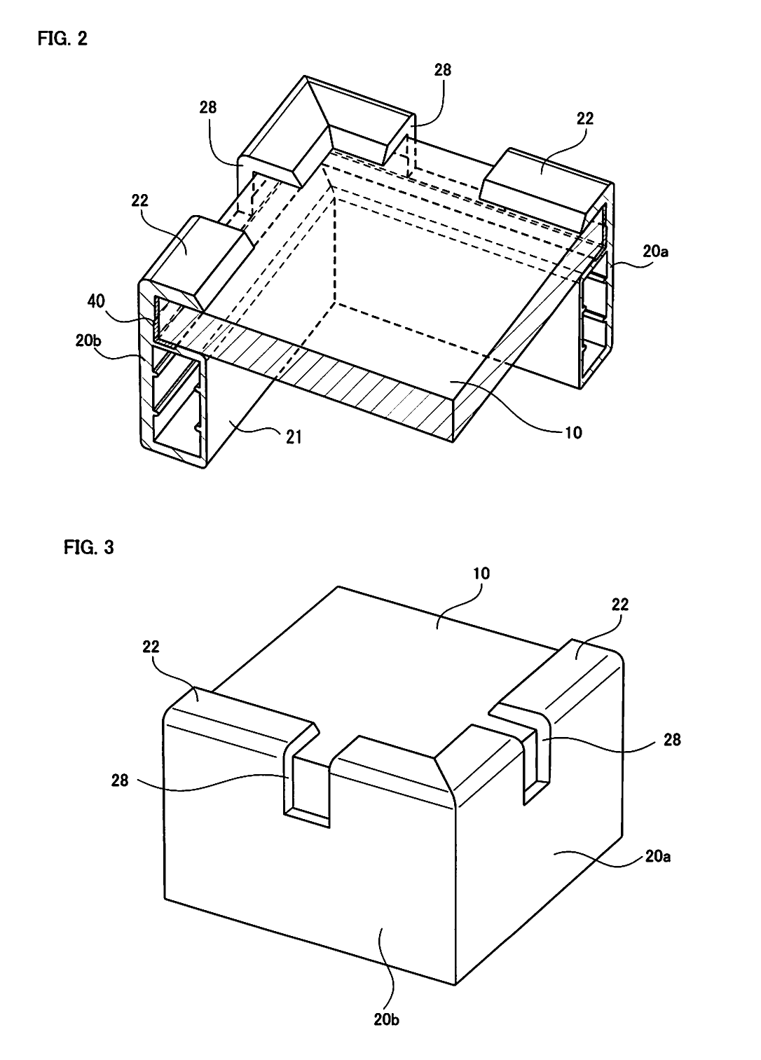

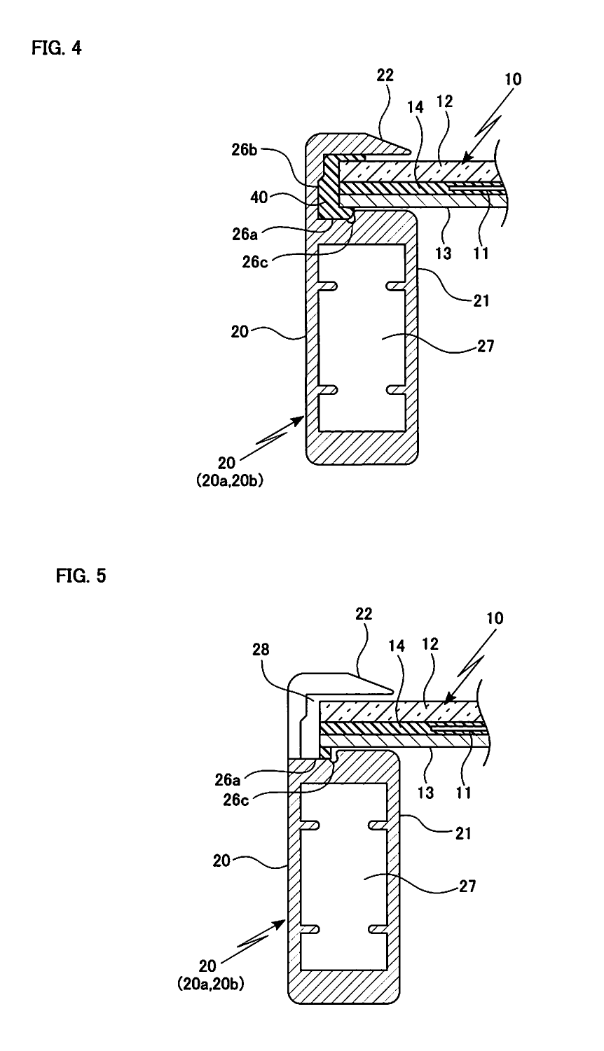

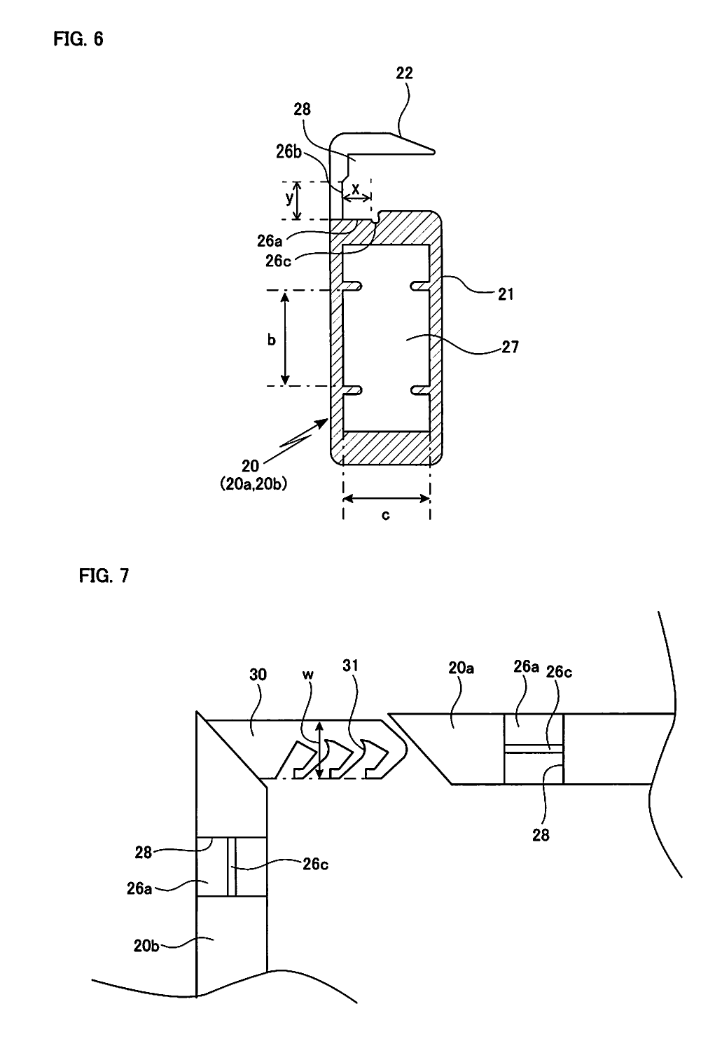

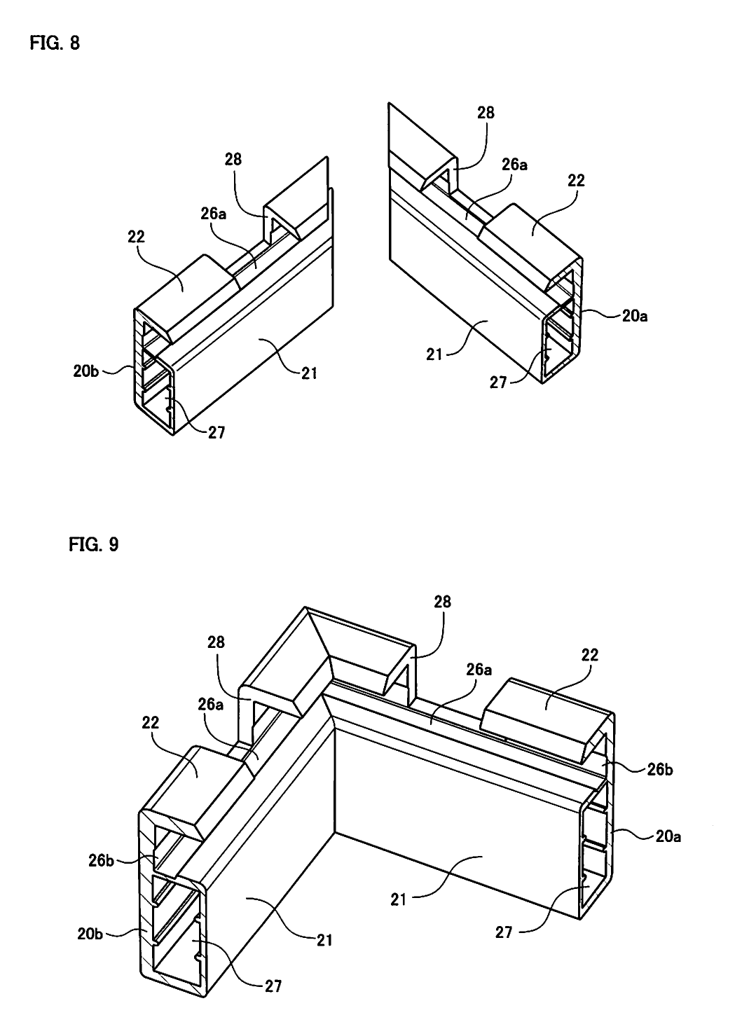

FIG. 1 is a plan view of a solar cell module according to the embodiment of the invention; FIGS. 2 and 3 are perspective views showing a relevant part of the solar cell module; FIGS. 4 and 5 are cross-sectional views showing a relevant part of the solar cell module; FIG. 6 is a sectional view showing a relevant part of flames utilized in the solar cell module according to the embodiment of the invention; FIG. 7 is a plan view showing assembly of a frame of the solar cell module according to the embodiment of the invention; FIG. 8 is an exploded perspective view showing assembly of the frame of the solar cell module according to the embodiment of the invention; FIG. 9 is a perspective view showing the assembled frame of the solar cell module according to the embodiment of the invention.

As shown in FIG. 1, the solar cell module 1 according to the invention includes a solar cell panel 10 and a frame 20 that protects the solar cell panel 10. The frame 20 includes a pair of first frames 20a disposed along the shorter sides of the solar cell panel 10 and a pair of second frames 20b disposed along the longer sides of the solar cell panel 10.

As shown in FIGS. 7 to 9, the first frames 20a and second frames 20b are coupled to each other at their ends in the longitudinal direction. The frame 20 formed by alternately coupling the first frames 20a and second frames 20b protects the solar cell panel 10. Thus configured solar cell module 1 is used after being attached on a mounting base (not shown) or the like. For example, the length of the first frame 20a is approximately 790 mm to 900 mm, and the length of the second frame 20b is approximately 1300 mm to 1600 mm.

The solar cell panel 10 is roughly rectangular in planar view. The solar cell panel 10, as shown in FIGS. 1 to 5, includes a plurality of solar cells 11 electrically interconnected with ribbons 102, which are made from a conductive material such as a copper foil, a transparent front member 12, and a back member 13 made of a weatherproof film. The solar cells 11 are sealed with a transparent encapsulant 14, such as excellent weather-resistant and moisture-resistant EVA (ethylene vinylacetate), between the front member 12 and back member 13.

The plurality of solar cells 11 connected with the ribbons 102 in series make up a string 110 as a unit of solar cells 11. The strings 110 and 110 are connected with a connecting wire, so-called a bus ribbon 111. In addition, end ribbons 112 are connected to extract outputs from the solar cells 11 to external equipment.

The solar cell 11 is, for example, a crystalline semiconductor made of monocrystalline silicon, polycrystalline silicon or the like, having a thickness of approximately 0.15 mm in the form of roughly a square of 100 mm for a side; however the present invention is not limited thereto, and other types of solar cell can be used.

In the solar cell 11, for example, there are an n-type region, a p-type region and a junction to form an electric field for carrier separation at the interface between the n-type region and the p-type region. An exemplary solar cell is a so-called hetero-junction with intrinsic thin layer solar cell capable of reducing defects at the interface and improving the hetero junction interface characteristics by interposing a substantially intrinsic amorphous silicon layer between a monocrystalline silicon substrate and an amorphous silicon layer.

The front member 12 is a light-transmissive plate through which light can pass to the solar cells 11. The front member 12 may be a glass plate made of clear glass, reinforced glass and heat-reflective glass or other types of glass, or a synthetic resin plate made of polycarbonate resin or other types of resin.

The back member 13 is made of Poly-Vinyl Fluoride (PVF), polyethylene terephthalate (PET) or Polyethylene naphthalate (PEN), a lamination thereof, or a PET film with an aluminum foil interposed.

The peripheral edge portion of the solar cell panel 10 is fitted in the frame 20, made of aluminum or the like, with a sealing material 40. The sealing material 40 can be silicone resin, butyl rubber, epoxy-based resin or urethane-based resin. In this embodiment, silicone resin is used as the sealing material 40.

If needed, a terminal box (not shown) is provided, for example, on a surface of the back member 13.

As shown in FIGS. 6 to 9, the first frames 20a and second frames 20b making up the frame 20 are made of, for example, aluminum, iron, stainless steel, resin or the like by extrusion processing or other methods. Each of these frames 20a, 20b includes a hollow main body 21 and a U-shaped cross-section fitting part 22 disposed on the top of the main body 21. The peripheral edge portion of the solar cell panel 10 is inserted into the fitting part 22 with the sealing material, such as silicone resin. On the upper face of the main body 21, which is a support portion positioned at the lower side of the fitting part 22, formed is a first recess 26a to which the sealing material is applied. On a wall of the fitting part 22 standing perpendicular to the first recess 26a, formed is a second recess 26b to which the sealing material is applied. In addition, a groove 26c for storing the sealing material is formed so as to connect with the recess 26a of the main body 21.

As shown in FIG. 6, the width (x) of the first recess 26a in the fitting part 22 is 3.5 mm in this embodiment, and the depth thereof is 0.8 mm. The width (y) of the second recess 26b is 4.0 mm in this embodiment, and the depth thereof is 0.5 mm. The width of the upper portion of the main body 21 is 9.3 mm, and the height of the interior portion of the fitting part 22 is 6.0 mm.

The frames 20a, 20b have rectangular attaching portions 27 at their corners to receive a press-fitted corner piece 30.

The corner piece 30 press-fitted into the attaching portion 27 is made of aluminum and has a hook portion 31 as shown in FIG. 7. As shown in FIGS. 5 and 7, the hook portion 31 has a width (w) slightly wider than the width (c) of the rectangular attaching portion 27 and a height equal to or slightly less than the height (b) of the attaching portion 27.

As shown in FIGS. 7 to 9, connection of the frames 20a, 20b is carried out by press-fitting one hook portion 31 of a corner piece 30 into an attaching portion 27 of a frame 20b (20a) and securing the corner piece 30 with pressure, and subsequently, press-fitting an other hook portion 31 of the corner piece 30 into an attaching portion 27 of a frame 20a (20b), thereby securely connecting the frames 20a and 20b.

The frames 20a, 20b have drainage notches 28 formed by partially cutting out the fitting part 22 to drain water stored on the front member 12 of the solar cell module 1. The number of the notches 28 is appropriately chosen according to the size of the solar cell module 1.

In this embodiment, as shown in FIG. 1, the frames 20a, 20b have a notch 28 at the opposite ends, respectively, near the corner regions where are likely to store water. In addition, the frames 20b disposed on the longer sides of the solar cell panel 10 have a notch 28 in the middle thereof, respectively. Accordingly, the frames 20a on the shorter sides have one notch 28 at the opposite ends, respectively, near the corner regions, in other words, each of the frames 20a has two notches 28 in total.

The frames 20b on the longer sides have one notch 28 at the opposite ends and one in the middle, in other words, each of the frames 20b has three notches 28 in total.

The notch 28 is formed by cutting out the frame so as to have a width within the range from approximately 5 mm to 10 mm and a height to be lower than the front member 12 of the solar cell panel 10 fitted in the frame 20. In this embodiment, the notch 28 is formed from the top end face of the vertically raised wall of the fitting part 22 to the recess 26a.

In addition, the notches 28 formed at the corner regions are positioned approximately 15 mm to 20 mm away from the corners.

Silicone resin, as a sealing material 40, is applied by a dispenser to the recesses 26a, 26b formed in the fitting part 22 of the frames 20a, 20b. Then, the peripheral edge portion of the solar cell panel 10 is inserted into the fitting part 22 of the frames 20a, 20b to attach the frames 20a, 20b to the solar cell panel 10.

If a silicone resin is applied to the first recess 26a and the second recess 26b close to the notch 28, the silicone resin is squeezed out to the notch's opening that positionally corresponds to the wall of the fitting part 22 of the frames 20a, 20b from the ambient of the notch 28. Therefore, according to the invention, the silicone resin is not applied to the surrounding area of the notch 28 so as to prevent the sealing material 40 including the silicone resin from being squeezed, improve workability of cleaning and the like and maintain a fine view. For this reason, according to the invention, the sealing material 40 is applied to the fitting part 22 with a predetermined spacing from an edge of the notch 28. As a result, as shown in FIG. 3, side surfaces of the solar cell panel 10 are exposed from the notch 28 to the outside. As mentioned above, the squeezed sealing material 40 including a silicone resin is not present, therefore, workability of cleaning or the like can be improved and a fine view can be maintained.

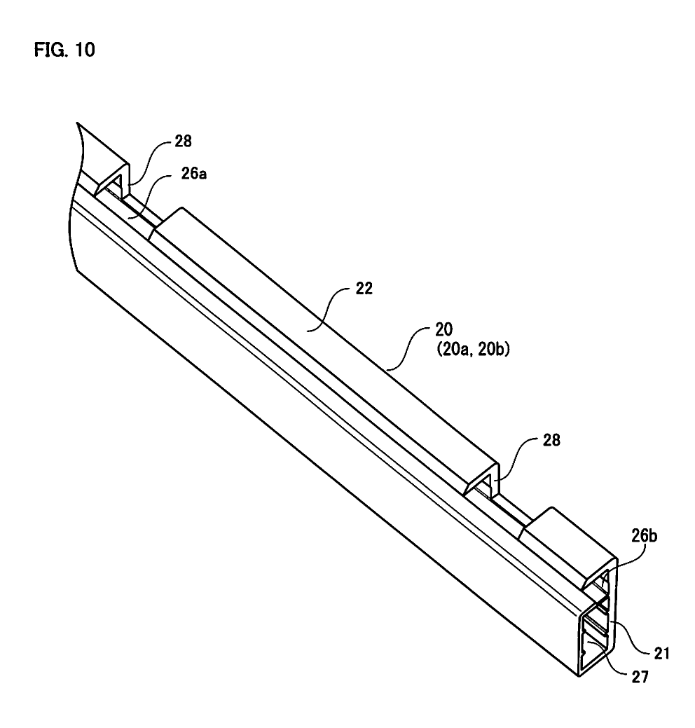

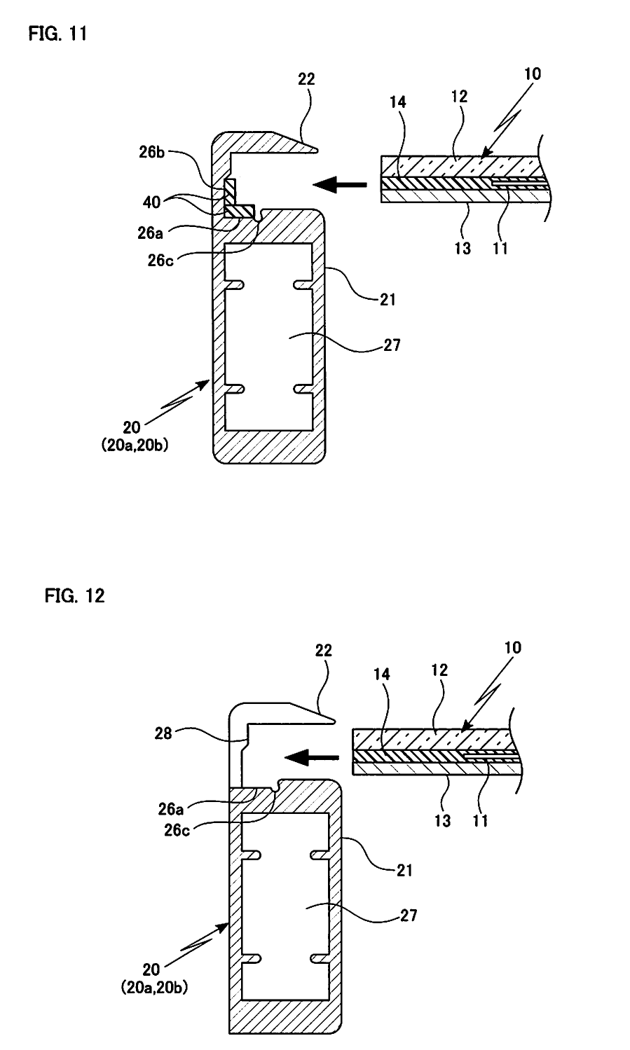

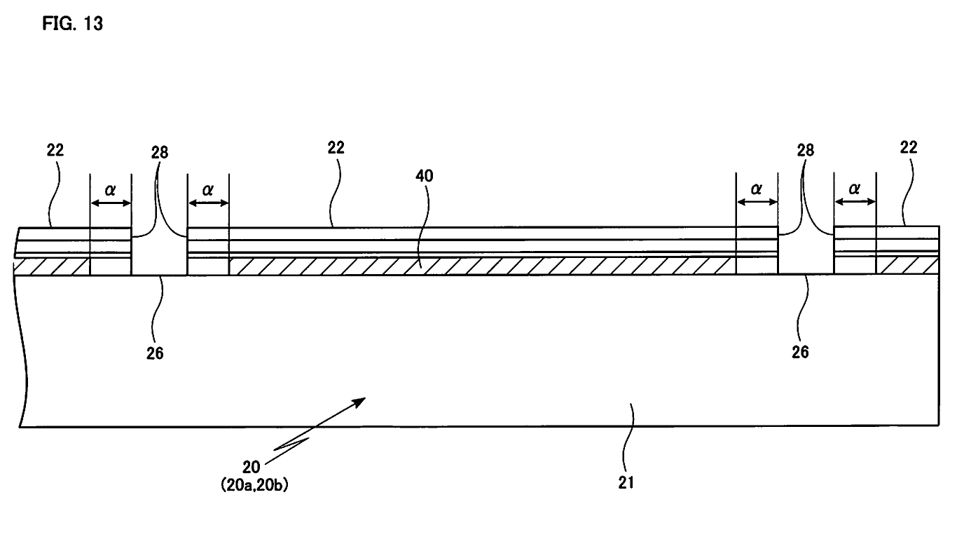

A manufacturing method for the invention will be described in detail with reference to FIGS.10 to 13. FIG. 10 is a perspective view showing the flames utilized in the solar cell module according to the embodiment of the invention. FIG. 11 is a cross-sectional view showing the method for manufacturing the solar cell module for the invention and particularly how to insert the solar cell panel into the frame. FIG. 12 is a cross-sectional view showing the method for manufacturing the solar cell module for the invention and particularly how to insert the solar cell panel into a notch of the frame. FIG. 13 is a front view showing the flame utilized in the solar cell module according to the embodiment of the invention.

In this embodiment, as shown in FIGS. 10 and 13, silicone resin 40 is applied to the recesses 26a and 26b of the fitting part 22 with a predetermined spacing (α) from an edge of the notch 28. Thereafter, as shown in FIGS. 11 and 12, the peripheral edge portion of the solar cell panel 10 is inserted.

According to the invention, a spacing (α) is varied in many ways so that the spacing (α) which the sealing materials are not squeezed out from the notch 28 to the front member 12 of the solar cell panel 10 is searched for.

Silicone resin, serving as the sealing material 40, is applied by a dispenser to the recesses 26a, 26b in the fitting parts 22. The amount of the applied silicone resin is 32 g/m. The spacing (α) from an edge of the notch 28 is set to be 10 mm, 20 mm and 30 mm, and silicone resin, serving as the sealing material 40, is applied by a dispenser to the recesses 26a, 26b in the fitting part 22 respectively. Then, after the peripheral edge portion of the solar cell panel 10 is fitted into the fitting part 22, the amount of the sealing material 40 squeezed out from the notch 28 is checked.

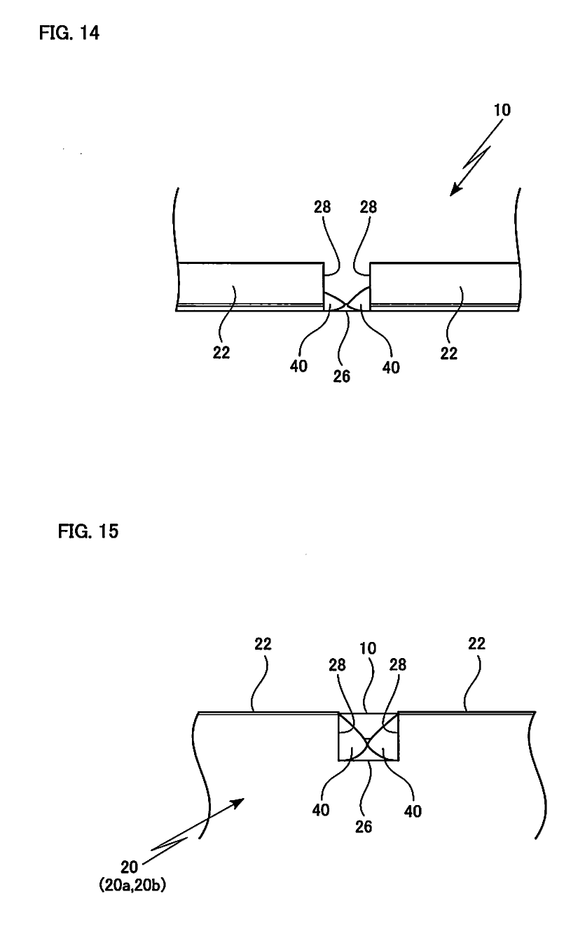

The state near the notch of the solar cell module when the spacing (α) from an edge of the notch 28 is set to be 10 mm and the silicone resin is applied, is shown in FIGS. 14 and 15. FIG. 14 is a plan view showing the notch region of the solar cell module manufactured according to a manufacturing method for the solar cell module of the invention. FIG. 15 is a rear view of same.

As shown in FIGS. 14 and 15, in the solar cell module when the spacing (α) from an edge of the notch 28 is set to be 10 mm and the silicone resin is applied, the sealing material 40 is squeezed out from the notch 28 to the front member 12 of the solar cell panel 10. Therefore, the work such as cleaning off this squeezed sealing material is required.

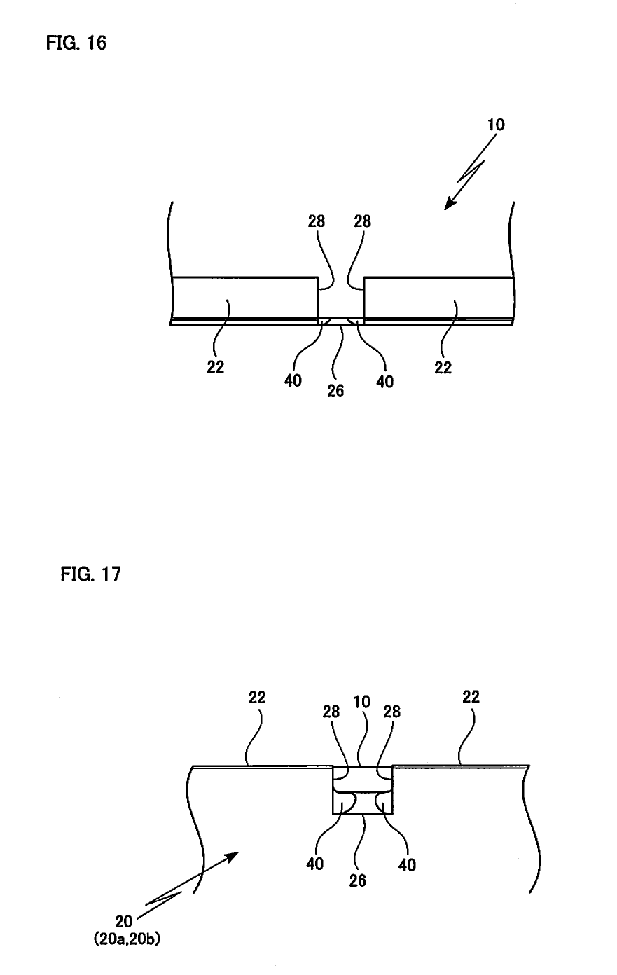

The state near the notch of the solar cell module when the spacing (α) from an edge of the notch 28 is set to be 20 mm and the silicone resin is applied, is shown in FIGS. 16 and 17. FIG. 16 is a plan view showing the notch region of the solar cell module manufactured according to a manufacturing method for the solar cell module of the invention. FIG. 17 is a rear view of same.

As shown in FIGS. 16 and 17, in the solar cell module when the spacing (α) from an edge of the notch 28 is set to be 20 mm and the silicone resin is applied, although the sealing material 40 is squeezed out a little from the notch 28, the sealing material 40 is not squeezed out to the front member 12 of the solar cell panel 10. Therefore, the work such as cleaning off the sealing material is not required.

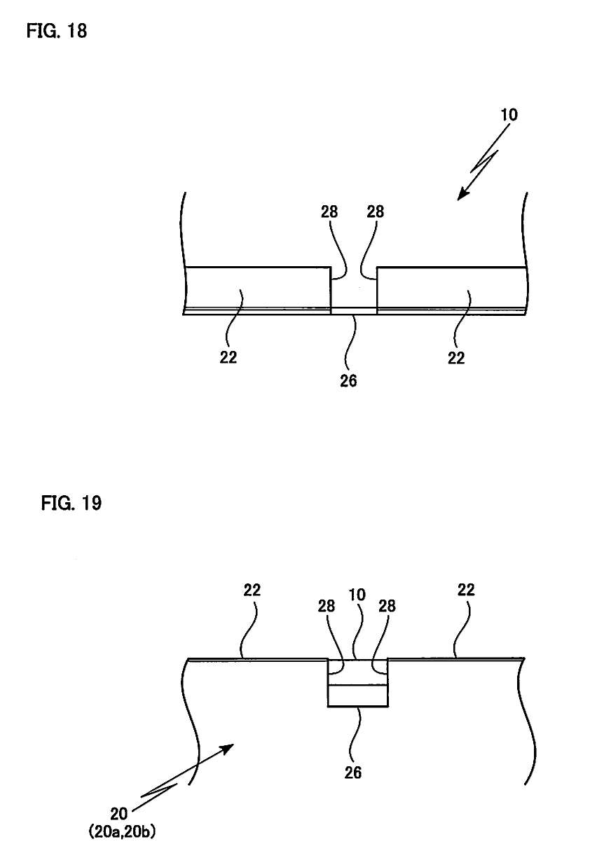

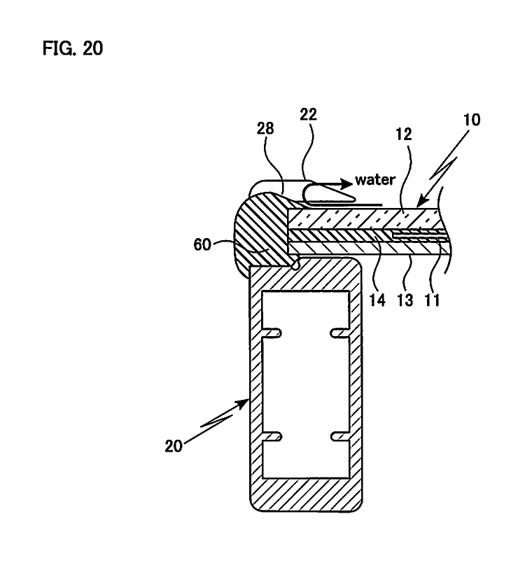

The state near the notch of the solar cell module when the spacing (α) from an edge of the notch 28 is set to be 30 mm and the silicone resin is applied, is shown in FIGS. 18 and 19. FIG. 18 is a plan view showing the notch region of the solar cell module manufactured according to a manufacturing method for the solar cell module of the invention. FIG. 19 is a rear view of same.

As shown in FIGS. 18 and 19, in the solar cell module when the spacing (α) from an edge of the notch 28 is set to be 30 mm and the silicone resin is applied, the sealing material 40 is not squeezed out from the notch 28. Therefore, the work such as cleaning off the sealing material is not required.

Consequently, in order to prevent the sealing materials from being squeezed out from the drainage notch 28 and eliminate the work such as cleaning off the sealing material, the sealing material 40 including silicone resin is applied to the recesses 26a and 26b of the fitting part 22 in a manner to keep a spacing which extends more than 10 mm to 30 mm from the edge of the notch. Thereafter, the peripheral edge portion of the solar cell panel 10 is fitted in the fitting part 22, and then the flame 20 is attached to the peripheral edge portion of the solar cell panel 10 so as to complete the solar cell module 1.

As mentioned above, since the sealing material 40 including silicone resin is applied in a manner to keep a spacing which extends more than 10 mm to 30 mm from the edge of the notch 28, the silicone resin does not exceed the front member 12 of the solar cell panel 10. Therefore, water can be smoothly drained from the notch 28.

In order to prevent water from entering in between the solar cell panel 10 and the flame 20, the sealing material may be applied to the notch 28 area after the solar cell panel 10 is fitted to improve the sealing properties. In this case, although a process to apply the sealing material is added, applying the sealing material is much easier than taking off the sealing material.

Although all of the first frames 20a and second frames 20b are configured to have notches 28, respectively, in the first and second embodiments, it is acceptable to provide the notch 28 to at least one of the first frames 20a and second frames 20b. In addition, there can be various possibilities in the number and position of the notches 28 to be formed in the frames 20a (20b).

It should be understood that the embodiments disclosed herein are to be taken as examples in every point and are not limited. The scope of the present invention is defined not by the above described embodiments, but by the appended claims. All changes that fall within means and bounds of the claims, or equivalence of such means and bounds are intended to be embraced by the claims.

### REFERENCE SIGNS LIST

10 solar cell module body

11 solar cell

20 frame

20a first frame

20b second frame

21 frame main body

22 fitting part

26a first recess

26b second recess

27 attaching portion

28 notch

30 corner piece

31 hook portion

40, 40a sealing material

1. A method for manufacturing a solar cell module, wherein the solar cell module includes:
a solar cell panel; and
a frame having a fitting part receiving a peripheral edge portion of the solar cell panel,
the frame includes a drainage notch formed by cutting out the fitting part from a position near a front member of the solar cell panel to a position below the front member, and
the peripheral edge portion of the solar cell panel is inserted in the fitting part after a sealing material is applied to the fitting part with more than 10 mm to 30 mm spacing from an edge of the notch to attach the frame to the peripheral edge portion of the solar cell panel.

2. The method for manufacturing the solar cell module according to claim 1, wherein the frame includes a main body, and the fitting part is positioned on the top of the main body.

3. The method for manufacturing the solar cell module according to claim 1, wherein the fitting part has a U-shape in cross section.

4. The method for manufacturing the solar cell module according to claim 1, wherein
the frame includes: a main body; and a U-shaped cross-section fitting part that is positioned on the top of the main body and receives the peripheral edge portion of the solar cell panel,
a first recess is formed on a top surface of the main body and is applied with the sealing material, the top surface being included in a support portion on the lower side of the fitting part; and
a second recess is formed in a wall of the fitting part and is applied with the sealing material, the wall standing perpendicular to the first recess.

5. The method for manufacturing the solar cell module according to claim 4, wherein 32 g/m sealing material made of silicone resin is applied to the first recess and second recess.

6. The method for manufacturing the solar cell module according to claim 4, wherein the first recess has a width of 3.5 mm and the second recess has a width of 4.0 mm.
